(19) United States
(12) Patent Application Publication
(10) Pub. No.: US 2014/0158021 A1
(43) Pub. Date: Jun. 12, 2014

(54) Electrochemical Synthesis of Selenium Nanoparticles

(71) Applicants: Wei Pan, Vancouver, WA (US); Sean Andrew Vail, Vancouver, WA (US)

(72) Inventors: Wei Pan, Vancouver, WA (US); Sean Andrew Vail, Vancouver, WA (US)

(21) Appl. No.: 13/711,356

(22) Filed: Dec. 11, 2012

(51) Int. Cl. C25C 1/22

(52) U.S. Cl. CPC C25C 1/22; B82Y 99/00
USPC 106/403; 205/560; 977/773; 977/899

(57) ABSTRACT

A method is provided for the electrochemical synthesis of selenium (Se) nanoparticles (NPs). The method forms a first solution including a Se containing material and a stabilizing first ligand, dissolved in a first solvent. The first solution is exposed to an electric field, and in response to the electric field, a second solution is formed with dispersed SeNPs. The Se containing material has either a nonzero or positive oxidation state. In one particular aspect, the first solution is formed by dissolving Se dioxide (SeO₂) in water to form selenosis acid (H₂SeO₃).

### RELATED APPLICATION

The application is a Continuation-in-Part of a pending application entitled, SOLUTION-PROCESSED METAL SELENIDE SEMICONDUCTOR USING SELENIUM NANOPARTICLES, invented by Sean Vail et al., Ser. No. 13/674,005, filed on Nov. 10, 2012, Attorney Docket No. SLA3211, which is incorporated herein by reference.

### BACKGROUND OF THE INVENTION

1. Field of the Invention

This invention generally relates to electrochemical synthesis and, more particularly, to the formation of selenium nanoparticles using an electrochemical synthesis process.

2. Description of the Related Art

In addition to functioning as an essential nutrient for cellular function in many organisms, selenium has been extensively utilized in many commercial and high-technology applications. Interestingly, selenium demonstrates both photovoltaic (conversion of light to electricity) and photoconductive (reduced electrical resistance in response to increased illumination) activity. In light of these properties, selenium is often employed in photocells, exposure meters for photography, and solar cells.

For many applications, elemental selenium cannot be practically employed as a powder (or other pristine form) for which a soluble selenium “vehicle” in the form of selenium nanoparticles (SeNPs) offers a viable alternative. Certainly, SeNPs can offer distinct advantages in terms of process versatility (as in solution-based materials fabrication) and/or bio-availability (as in nutritional, therapeutic and/or medicinal applications). Since selenium is an important nutritional supplement, an overwhelming majority of the prior art has focused on bio-compatible SeNPs, whereby the nanoparticles are effectively stabilized by large moieties such as hyperhranched polysaccharides, proteins, and/or high molecular weight polymers, and biopolymers, etc.

Regardless of the target application, the fabrication of SeNPs reported in the prior art has been dominated by conventional “chemical” or “thermal” approaches whereby a soluble selenium “precursor” species is transformed to SeNPs upon the action of a chemical reagent under a specified set of conditions and, almost always, in the presence of an appropriate stabilizing agent (or ligand), which functions to both control SeNP growth and stabilize the resultant collection of SeNPs in solution. To a lesser extent, the synthesis of SeNPs has been successfully demonstrated via microbiological processes. Below is provided a survey of methodologies for SeNP fabrication as described in the prior art.

Mees et al. described the synthesis of selenium colloids in quantitative yield from selenous acid (H₂SeO₃) using sodium ascorbate as the reducing agent either in the presence of sodium dodecyl sulfate (SDS) surfactant at room temperature or, alternatively, in the absence of surfactant at elevated temperatures.¹ Rajalakshmi et al. reported the synthesis of SeNPs via precipitation in a viscous polymer solution.² Liu et al. described the preparation of SeNPs by a reverse microemulsion process using sodium selenosulfate as the selenium source.³ Lin et al, reported the fabrication of SeNPs through a mild chemical reduction method involving H₂SeO₃ (selenium source), SDS, and sulfur dioxide (reducing agent).⁴ Subsequently, Lin et al. described a facile, size selective method for synthesizing amorphous SeNPs at room temperature with H₂SeO₃, SDS (surfactant, ligand), and sodium thiosulfate as reducing agent.⁵ Ingole et al. provided a method for a “green” synthesis of glucose-stabilized SeNPs from sodium selenosufate at elevated temperatures.⁶ Zhang et al. described the fabrication of water-dispersible SeNPs from H₂SeO₃using a hyperbranched polysaccharide (HBP) as stabilizer/capping agent in the presence of ascorbic acid.⁷ Chen et al. provided a process for the large scale preparation of trigonal selenium nanowires and nanotubes from sodium selenite (Na₂SeO₃) and glucose without the need for additional templates or surfactants.⁸ Finally, Dwivedi et al. described a simple method for preparing SeNPs (40-100 nm) by reaction of sodium selenosulfate with various organic acids in the presence of polyvinyl alcohol (PVA) as stabilizer in aqueous media.⁹

In contrast to conventional “chemical” strategies for producing selenium nanostructures, several “biological” methodologies appear in the patent literature. Hanson described the capability of selenite-resistant (or tellurite-resistant) marine organisms to precipitate selenium (or tellurium) when grown aerobically.¹⁰ Furthermore, a method for utilizing the isolated organisms to produce aqueous suspensions of purified selenium (or tellurium) nanoparticles is provided. Prokisch and Zommara reported the production of elemental selenium nanospheres and compositions thereof by microbiological methods using non-selenium-respiring bacteria.¹¹ In general, the compositions and materials are suggested as being useful as food additives and for application in the microelectronic and optical industries. Finally, Mester et al. provided a method for producing sulfur-free nanoparticles.¹² in general, the approach involves growing yeast within a medium containing a source of element in a bio-reducible oxidation state with precipitation of nanoparticles containing the element in a lower oxidation state than that of the original (element) source.

Overall, although the preparation of a variety of nano-selenium forms has been demonstrated by various strategies, the reduction method appears the most prevalent and includes chemical, bacterial, γ-radiolytic, etc. in contrast, oxidative methods have also been successfully employed such as in the electrochemical oxidation of inorganic selenides.¹³ In this case, the electro-oxidation of sulfides, selenides, and tellurides was demonstrated in cationic surfactant-aqueous sodium hydroxide suspensions in both slurry cell and sandwich cell configurations.

In a general sense, the numerous advantages of nanomaterials (relative to “bulk” materials) are well known by those skilled in the art. As a result, the treatment of nanomaterials herein is limited to selenium. Gao and Khan provided a novel method for chemopreventive and chemotherapeutic cancer treatment using elemental selenium nanoparticles.¹⁴ In accordance with this technology, apoptosis is induced in cancer cells that are exposed to selenium through selenium nanoparticle treatment. Researchers at Brown University described a method for using a sorbent material to capture and stabilize mercury whereby the sorbent matrix feature nanoparticles in one embodiment.¹⁵

In a parent application entitled, SOLUTION-PROCESSED METAL SELENIDE SEMICONDUCTOR USING SELENIUM NANOPARTICLES, invented by Sean Vail et al., Ser. No. 13/674,005, filed on Nov. 10, 2012, a strategy was presented for the synthesis and subsequent integration of SeNPs for solution-based processing of a copper indium gallium diselenide (CuIn₁₋ₓGaₓSe₂) PV absorber layer. Essentially, the SeNPs were designed to function as a vehicle for supplying selenium directly into the absorber layer during the deposition process. An additional selenium supply in the deposited absorber layer, at a minimum, reduced the extent to which high temperature post-selenization would be required while, at the same time, improved both overall CIGS film growth and interfacial contacts. Indeed, CIGS solar cells fabricated with SeNPs demonstrated improved performance (higher efficiency) relative to control devices (no SeNPs).

1. D. R. Mees, W. Pysto and P. J. Tarcha, “Formation of Selenium Colloids Using Sodium Ascorbate as the Reducing Agent”, Journal of Colloid and Interface Science 1995, 170, 254-260.

2. M. Rajalakshmi and A. K. Arora, “Optical Properties of Selenium Nanoparticles Dispersed in Polymer”, Solid State Communications 1999, 110, 75-80.

3. M. Z. Liu, S. Y. Zhang, Y. H. Shen and M. L. Zhang, “Selenium Nanoparticles Prepared from Reverse Microemulsion Process”, Chinese Chemical Letters 2004, 15, 1249-1252.

4. Z-H, Lin, F-C. Lin and C. R. C. Wang, “Observation in the Growth of Selenium Nanoparticles”, Journal of the Chinese Chemical Society 2004, 51, 239-242.

5. Z-H. Lin and C. R. C. Wang, “Evidence on the Size-Dependent Spectral Evolution of Selenium Nanoparticles”, Materials Chemistry and Physics 2005, 92, 591-594.

6. A. R. Ingole, S. R. Thakare, N. T. Khati, A. V. Wankhade and D. K. Burghate, “Green Synthesis of Selenium Nanoparticles Under Ambient Conditions”, Chalcogenide Letters 2010, 7, 485-489.

7. Y. Zhang, J. Wang and L. Zhang, “Creation of High Stable Selenium Nanoparticles Capped with Hyperbranched Polysaccharide in Water”, Langmuir 2010, 26, 17617-17623.

8. H. Chen, D-W, Shin, J-G. Nam, K-W. Kwon and J-B. Yoo, “Selenium Nanowires and Nanotuhes Synthesized via a Facile Template-Free Solution Method”, Materials Research Bulletin 2010, 45, 699-704.

9. C. Dwivedi, C. P. Shah, K. Singh, M. Kumar and P. N. Bajaj, “An Organic Acid-Induced Synthesis and Characterization of Selenium Nanoparticles”, Journal of Nanotechnology 2011, Article ID 651971.

10. T. E. Hanson, “Biosynthesis of Metalloid Containing Nanoparticles by Aerobic Microbes”, US20090246519 A1.

11. J. Prokisch and M. A. Zommara, “Process for Producing Elemental Selenium Nanospheres”, US20100189634 A1 and U.S. Pat. No. 8,003,071 B2.

12. Z. Mester and L. Ouerdane, “Production of Sulfur-Free Nanoparticles by Yeast”, US2011/0135932 A1.

13. T. C. Franklin, W. K. Adeniyi and R. Nnodimele, “The Electro-oxidation of Some Insoluble Inorganic Sulfides, Selenides, and Tellurides in Cationic Surfactant-Aqueous Sodium Hydroxide Systems”, Journal of The Electrochemical Society 1990, 137, 480-484.

14. X. Gao and L. Kong, “Treatment of Cancer with Selenium Nanoparticles”, US20110262564 A1.

15. R. H. Hurt, S. P. Hamburg, L. Sarin and I. Kulaots, “Nanostructured Sorbent Materials For Capturing Environmental Mercury Vapor”, US20110053766 A1, US20110052463 A1, US20110049045 A1 and US20110048982 A1.

It would be advantageous if a method existed for synthesizing SeNPs using a simple electrochemical process.

### SUMMARY OF THE INVENTION

Described herein a simple and low-cost technique for synthesizing SeNPs by purely electrochemical methods. Conveniently, the electrochemical reduction of a selenium precursor dissolved in water proceeds in the presence of a stabilizer (ligand) at room temperature without the requirement for chemical reducing agent(s). The evolution of SeNP formation and growth is visually apparent and has been confirmed by optical methods performed over the course of the process. The electrochemical synthesis route can provide a level of control over SeNP growth kinetics and dynamics that is not similarly possible using chemical reduction methods. In general, the method is amenable to a continuous flow configuration for high-throughput processing. Furthermore, the lack of a required chemical reducing reagent to initiate SeNP formation minimizes the need for subsequent purification of the as-synthesized SeNPs.

Conveniently, the method offers versatility in terms of stabilizing agent, which may be selected based upon the target application. For example, polymers and/or biopolymers may be dissolved in the same solution as the selenium precursor to function as stabilizer. In this case, the electrochemical synthesis leads to SeNPs dispersed in a polymer matrix, which may be subsequently processed into a film or other form. Alternatively, the electrochemical synthesis of SeNPs may occur in the presence of simple (or complex) biomolecules, thereby providing materials appropriate for nutritional, medicinal or therapeutic applications. Finally, the SeNPs may be recovered from aqueous solution following synthesis by centrifugation and subsequently re-dispersed into an appropriate medium containing a stabilizing agent (optionally) for solution-based processing of various composite materials (copper indium gallium diselenide (CIGS), for example).

Accordingly, a method is provided for the electrochemical synthesis of selenium (Se) nanoparticles (NPs). The method forms a first solution including a Se containing material and a stabilizing first ligand, dissolved in a first solvent. The first solution is exposed to an electric field, and in response to the electric field, a second solution is formed with dispersed SeNPs. The Se containing material has either a nonzero oxidation state or positive oxidation state. In one particular aspect, a first solution is formed by dissolving Se dioxide (SeO₂) in water to form selenous acid (H₂SeO₃).

The first ligand may be one of the following materials: ethylene glycol, glycerol, propylene glycol, polyols, monosaccharides, polysaccharides, ethylenediaminetetraacetic acid tetrasodium salt (NaEDTA), potassium sodium tartrate, polymers, biopolymers, and biomolecules, and combinations thereof. However, the use of other unmentioned ligands is possible.

In one aspect, a first material is added to the first solution to adjust the pH. For example, the pH is adjusted by adding one of the following materials: sodium hydroxide (NaOH), ammonium hydroxide (NH₄OH), acetate (CH₃CO₂), bicarbonate (HCO₃—), borate (BO₃³⁻), carbonate (CO₃²⁻), organic carboxylates (RCO₂—), cyanide (—CN), formate (HCO²⁻), hydroxide (—OH), oxalate (O₂C₂O₂²⁻), phosphate (PO₄³⁻), sulfate (SO₄²⁻), inorganic bases, organic bases, and combinations thereof.

Additional details of the above-described method, and a solution of stabilized SeNPs, are provided below.

### BRIEF DESCRIPTION OF THE DRAWINGS

FIG. 1 is a schematic diagram depicting a solution of stabilized selenium (Se) nanoparticles (NPs).

FIG. 2 is a flowchart illustrating a method for the electrochemical synthesis of selenium nanoparticles.

FIG. 3 is an alternate flowchart illustrating a method for the electrochemical synthesis of SeNPs.

FIG. 4 is a schematic diagram depicting experimental methods used to successfully demonstrate and verify the proof-of-concept fabrication of SeNPs by electrochemical methods.

FIGS. 5 and 6 are graphs depicting the evolution of SeNP formation via electrochemical synthesis using a solution consisting of SeO₂ (0.1 M), NaEDTA (0.6 M), and NaOH dissolved in water (pH=10.6).

### DETAILED DESCRIPTION

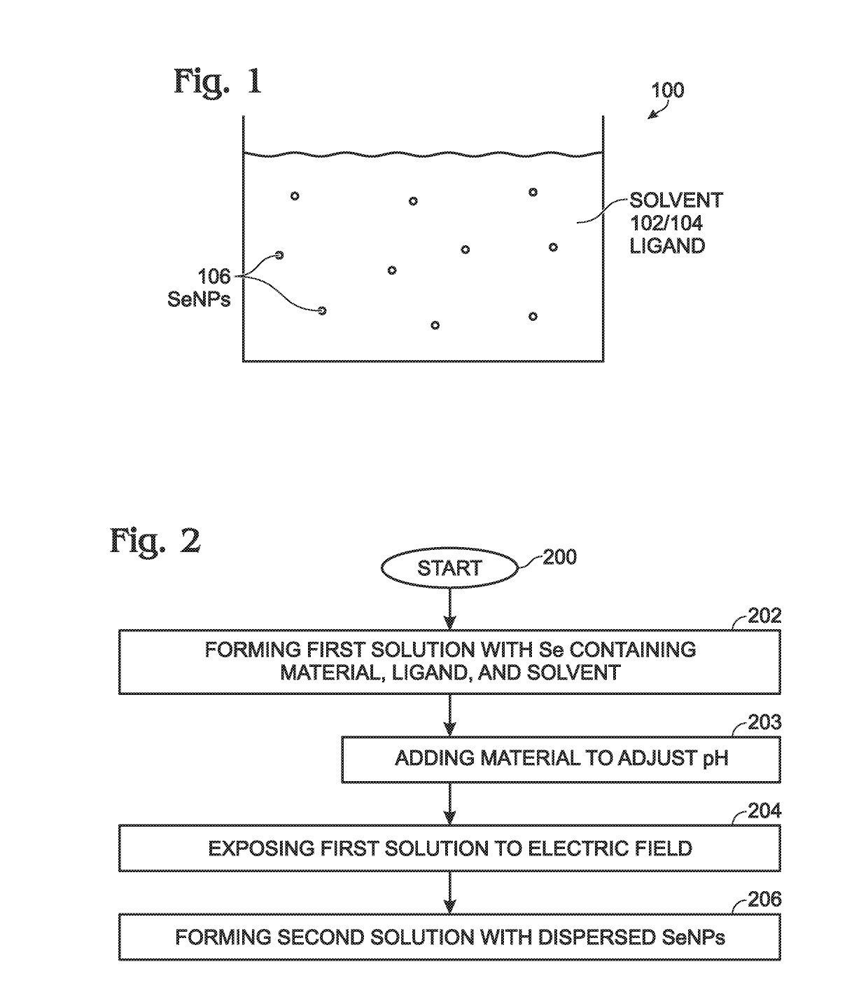

FIG. 1 is a schematic diagram depicting a solution of stabilized selenium (Se) nanoparticles (NPs). The solution 100 comprises a solvent 102. For example, the solvent may be water. The solution also comprises a ligand 104 as follows: ethylene glycol, glycerol, propylene glycol, polyols, monosaccharides, polysaccharides, ethylenediaminetetraacetic acid tetrasodium salt (NaEDTA), potassium sodium tartrate, polymers, biopolymers, biomolecules, or combinations thereof. SeNPs 106 are dispersed in the solvent 102 with the ligand 104. Stabilization by ligand involves modulating SeNP growth and size while, at the same time, balancing the attractive and repulsive forces between adjacent SeNPs, thereby reducing the tendency for SeNP aggregation in order to provide a stable suspension of SeNPs in solution. Electrochemical processes for synthesizing the solution 100 are presented below.

FIG. 2 is a flowchart illustrating a method for the electrochemical synthesis of selenium nanoparticles. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method begins at Step 200.

Step 202 forms a first solution including a Se containing material and a stabilizing first ligand, dissolved in a first solvent. Typically, the Se containing material has either a nonzero or positive oxidation state. A positive value oxidation state implies that So can be electrochemically reduced during the process to follow (Step 204).

Possible ligands include, but are not limited to, ethylene glycol, glycerol, propylene glycol, polyols, monosaccharides, polysaccharides, ethylenediaminetetraacetic acid tetra sodium salt (NaEDTA), potassium sodium tartrate, polymers, biopolymers, biomolecules, or combinations thereof. Typically, the first solvent is water. In one aspect, the first solution is formed by dissolving Se dioxide (SeO₂) in water to form selenous acid (H₂SeO₃).

Step 204 exposes the first solution to an electric field. Typically, Step 204 decreases the oxidation state of Se in the Se containing material in the first solution. For example, Step 204 may simultaneously expose the first solution to a first electrode having a first voltage potential, and a second electrode having a second voltage potential, different than the first voltage potential. In one aspect, the difference between the first potential and second potential is greater than the reduction potential of Se in the Se containing material in the first solution, to elemental selenium [Se(0)]. In another aspect, Step 204 continually flows a supply of the first solution between the first and second electrodes. For example, the first solution may be kept in a reservoir with an output stream passing between the electrodes, or the first solution may he continuously formed in Step 202 and immediately passed between the electrodes. Either way, a current may he created between the first electrode and the second electrode that is in the range of 5 milliamps per square centimeter (mA/cm²) to 50 mA/cm². The first electrode is a metal such as platinum (Pt) or gold (Au), and the second electrode is a metal such as Pt, titanium (Ti), copper (Cu), molybdenum. (Mo), or chromium (Cr). However, other metals may possibly be used.

In response to the electric field, Step 206 forms a second solution with dispersed SeNPs. In one aspect, Step 203 adds a first material to the first solution to adjust the pH. Typically, the pH is increased. The first material may he one of the following: sodium hydroxide (NaOH), ammonium hydroxide (NH₄OH), acetate (CH₃CO₂—), bicarbonate (HCO₃—), borate (BO₃³⁻), carbonate (CO₃²⁻), organic carboxylates (RCO₂—), cyanide (—CN), formate (HCO²⁻), hydroxide (—OH), oxalate (O₂C₂O₂²⁻), phosphate (PO₄³⁻), sulfate (SO₄²⁻), inorganic bases, organic bases, or combinations thereof.

In one aspect, exposing the first solution to the electric field in Step 204 includes exposing the first solution for a variable duration of exposure time. Then, forming the second solution with dispersed SeNPs in Step 206 includes controlling the size of the SeNPs in response to varying the duration of the exposure time. In another aspect, Step 206 increases the concentration of SeNPs in response to increasing the duration of the exposure time.

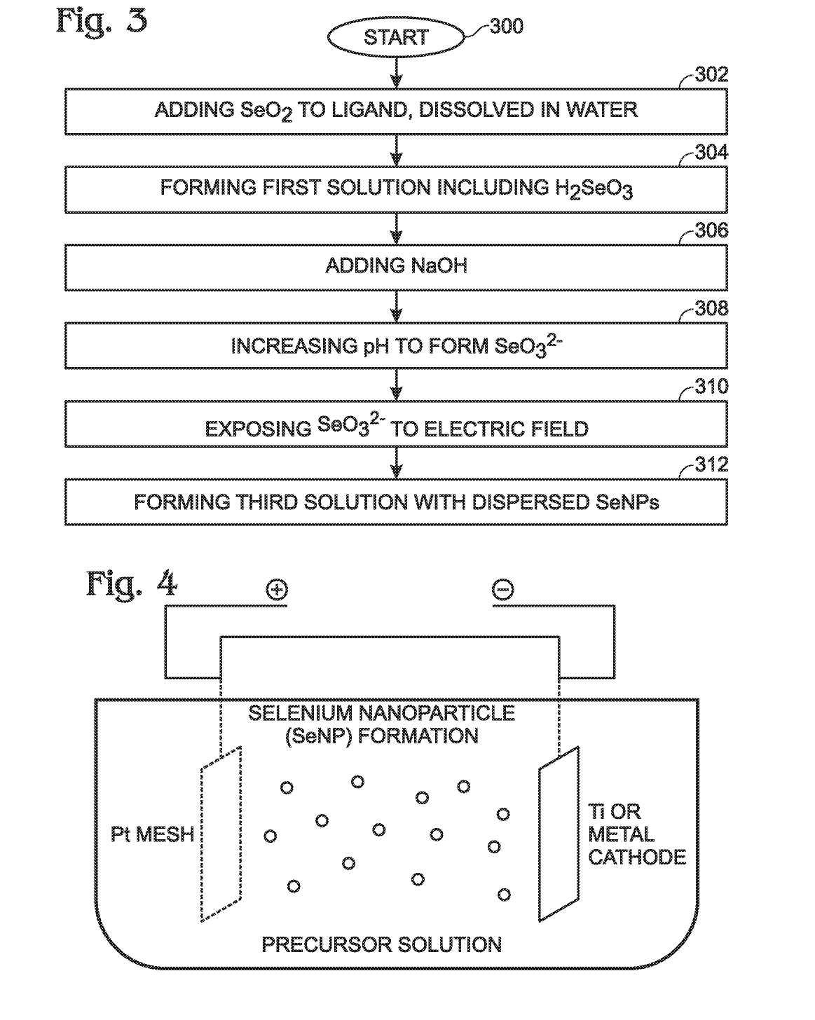

FIG. 3 is an alternate flowchart illustrating a method for the electrochemical synthesis of SeNPs. The method begins at Step 300. Step 302 adds selenium dioxide (SeO₂) to a ligand, dissolved in water. In one aspect, the ligand is ethylenediaminetetraacetic acid tetrasodium salt (NaEDTA). Step 304 forms a first solution including H₂SeO₃. Step 306 adds sodium hydroxide (NaOH) to the first solution including H₂SeO₃. Step 308 increases the pH to form SeO₃²⁻ in a basic second solution. Step 310 exposes the SeO₃²⁻ to an electric field. In response to the electric field, Step 312 forms a third solution with dispersed SeNPs. Additional process details and the materials that might he used to enable the method of FIG. 3 can be inferred by a person with skill in the art, in light of the description of FIG. 2.

The electrochemical reduction of Se precursor (H₂SeO₃) is promoted at a basic pH (pH>10). At a basic pH, the H₂SeO₃ actually exists as SeO₃²⁻ in solution. The H₂SeO₃ can also be transformed to SeNPs under acidic conditions, albeit less efficiently or at least more slowly. While NaOH is known to work well, there exist a number of bases that may be used as an alternative (see Step 203 of FIG. 2). Further, adjustments to create a basic pH may be considered as optional.

Considering the electrode overpotential and the conductivity of the first solution, the voltage difference is usually larger than the reduction potential. A common practice is to use a forced current mode so that a regulated constant current is established between two electrodes. The larger the current is, the faster the reaction. The current may be ranged between 5 mA/cm² and 50 mA/cm².

FIG. 4 is a schematic diagram depicting experimental methods used to successfully demonstrate and verify the proof-of-concept fabrication of SeNPs by electrochemical methods. The SeNP precursor solution consisted of 0.1 M selenium dioxide (SeO₂) and 0.6 M ethylenediaminetetraacetic acid tetrasodium salt (NaEDTA, as stabilizer) dissolved in water. The pH of the solution was adjusted to 10.6 by addition of NaOH. The above-mentioned solution was subjected to electrochemical treatment as follows:

1) The solution, as described above, was poured into a vessel in which a pair of parallel electrodes was configured, as illustrated in the figure. The anode electrode is made of precious metals such as a platinum mesh while the cathode is selected from a list of metal materials or metal coated glasses which include, but is not limited to, Ti, Cu, Mo, Cr, Al, etc.

2) The solution was stirred while a constant current (ranging from 5 mA/cm² to 25 mA/cm²) was flowed between the electrode pair.

3) In one preferred current setting of 15 mA/cm², the electrochemical synthesis process was carried out for a certain amount of time. During that period of time, several batches of electrochemically treated solutions were drawn from the container (at different time intervals) into a cuvette for optical characterization.

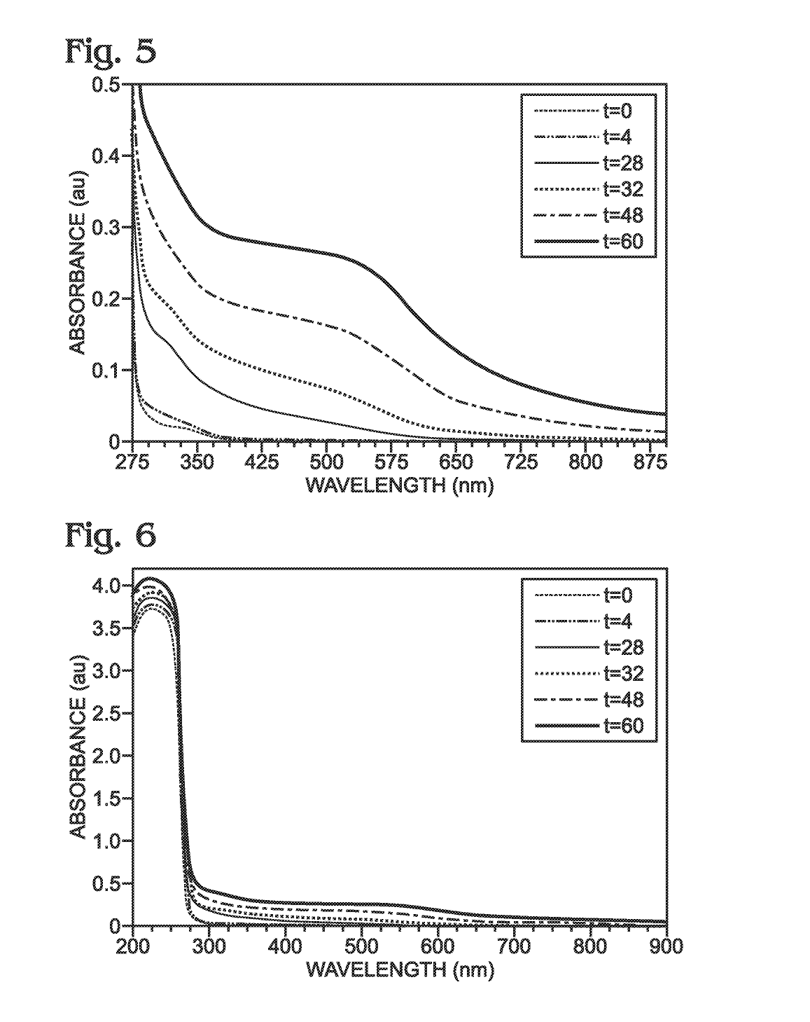

FIGS. 5 and 6 are graphs depicting the evolution of SeNP formation via electrochemical synthesis using a solution consisting of SeO₂ (0.1 M), NaEDTA (0.6 M), and NaOH dissolved in water (pH=10.6). The spectra correspond to individual aliquots removed during the course of the electrochemical reaction at t=0, 4, 28, 32, 48, and 60 minutes, respectively. [y-axis: Absorbance in arbitrary units (au); x-axis: Wavelength in nanometers (nm)].

Prior to electrochemical synthesis, the starting precursor solution was both colorless and transparent. During the course of the process the color of the electrochemical reaction bath transitioned from colorless→yellow→orange→red over the course of 60 minutes due to SeNP formation and growth.

The demonstrated technology provides a simple and low-cost technique for synthesizing SeNPs by purely electrochemical methods. The electrochemical reduction of a selenium precursor (to SeNPs) proceeds without the requirement for separate chemical reducing agent(s). The electrochemical synthesis route can provide a level of control over SeNP formation and growth that is not similarly possible using conventional methods. Further, the electrochemical method is amenable to a continuous flow configuration for high-throughput processing. The method offers versatility in terms of stabilizing agent, which may be strategically selected based upon the target application: functional films, nutritional/medicinal/therapeutic, and solution processing of composite materials (CIGS), etc.

Electrochemical processes have been provided for forming SeNPs. Also provided is a solution with stabilized SeNPs. Examples of materials, solvents, and process variables have been presented to illustrate the invention. However, the invention is not limited to merely these examples. Other variations and embodiments of the invention will occur to those skilled in the art.

We claim:

1. A method for the electrochemical synthesis of selenium (Se) nanoparticles (NPs), the method comprising:
forming a first solution including a Se containing material and a stabilizing first ligand, dissolved in a first solvent;
exposing the first solution to an electric field; and,
in response to the electric field, forming a second solution with dispersed SeNPs.

2. The method of claim 1 wherein forming the first solution includes forming the first solution with a Se containing material having an oxidation state selected from a group consisting of a nonzero and positive oxidation state.

3. The method of claim 1 wherein forming the first solution includes dissolving selenium dioxide (SeO₂) in water to form selenous acid (H₂SeO₃).

4. The method of claim 1 wherein the first ligand is selected from a group consisting of ethylene glycol, glycerol, propylene glycol, polyols, monosaccharides, polysaccharides, ethylenediaminetetraacetic acid tetrasodium salt (NaEDTA), potassium sodium tartrate, polymers, biopolymers, biomolecules, and combinations thereof.

5. The method of claim 1 wherein the first solvent, is water.

6. The method of claim 1 further comprising:
adding a first material to the first solution to adjust the pH.

7. The method of claim 6 wherein adjusting the pH includes increasing the pH.

8. The method of claim 6 wherein the first material is selected from a group consisting of sodium hydroxide (NaOH), ammonium hydroxide (NH₄OH), acetate (CH₃CO₂—), bicarbonate (HCO₃—), borate (BO₃³⁻), carbonate (CO₃²⁻), organic carboxylates (RCO₂—), cyanide (—CN), formate (HCO²⁻), hydroxide (—OH), oxalate (O₂C₂O₂²⁻), phosphate (PO₄³⁻), sulfate (SO₄²⁻), inorganic bases, organic bases, and combinations thereof.

9. The method of claim 1 wherein exposing the first solution to the electric field includes simultaneously exposing the first solution to a first electrode having a first voltage potential, and a second electrode having a second voltage potential, different than the first voltage potential.

10. The method of claim 9 wherein the difference between the first potential and second potential is greater than a reduction potential of Se in the Se containing material in the first solution, to elemental selenium [Se(0)].

11. The method of claim 9 wherein exposing the first solution to the electric field includes continually flowing a supply of the first solution between the first and second electrodes.

12. The method of claim 9 wherein exposing the first solution to the electric field includes creating a current between the first electrode and the second electrode in a range of 5 milliamps per square centimeter (mA/cm²) to 50 mA/cm².

13. The method of claim 9 wherein the first electrode is a metal selected from a group consisting of platinum (Pt) and gold (Au), and the second electrode is a metal selected from a group consisting of Pt, titanium (Ti), copper (Cu), molybdenum (Mo), and chromium (Cr).

14. The method of claim 1 wherein exposing the first solution to the electric field includes exposing the first solution for a variable duration of exposure time; and,
wherein forming the second solution with dispersed SeNPs includes controlling a size of the SeNPs in response to varying the duration of the exposure time.

15. The method of claim 1 wherein exposing the first solution to the electric field includes exposing the first solution for a variable duration of exposure time; and,
wherein forming the second solution with dispersed SeNPs includes increasing a concentration of SeNPs in response to increasing the duration of the exposure time.

16. The method of claim 1 wherein exposing the first solution to the electric field includes decreasing an oxidation state of Se in the Se containing material in the first solution.

17-19. (canceled)
